(19) United States
(12) Patent Application Publication
(10) Pub. No.: US 2009/0210612 A1
(43) Pub. Date: Aug. 20, 2009

(54) MEMORY CONTROLLER, NONVOLATILE MEMORY DEVICE, AND NONVOLATILE MEMORY SYSTEM

(75) Inventors: Masahiro Nakanishi, Kyoto (JP); Masayuki Toyama, Osaka (JP); Yutaka Nakamura, Kyoto (JP); Yasushi Gohou, Osaka (JP); Masanori Matsuura, Osaka (JP); Manabu Inoue, Osaka (JP); Tomoaki Izumi, Osaka (JP); Tetsushi Kasahara, Osaka (JP); Kazuaki Tamura, Osaka (JP); Kiminori Matsuno, Osaka (JP); Shunichi Iwanari, Kyoto (JP); Shinichi Tokumitsu, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/282,693

(22) PCT Filed: Mar. 12, 2007
(86) PCT No.: PCT/JP2007/054828

§ 371 Date: Jan. 14, 2009

(30) Foreign Application Priority Data
Mar. 16, 2006 (JP) 2006-072326

(51) Int. Cl. G06F 12/00; G06F 12/02

(52) U.S. Cl. 711/103; 711/E12.001; 711/E12.008; 711/115

(57) ABSTRACT

In rewriting processing of logical sectors, data of the transferred logical sectors are temporarily stored in a memory buffer. When the buffer memory has been full filled with data, the data is written into a flash memory. In rewriting processing for the flash memory including a writing unit (page) having a capacity larger than a minimum writing unit (sector) from outside, the number of executions of the evacuation processing can be reduced and the fast data rewriting can be performed. Thus, it is possible to rationalize the evacuation processing for old data caused in the rewriting in units of sectors and to improve the data rewriting speed.

### TECHNICAL FIELD

The present invention relates to a nonvolatile memory device having a rewritable nonvolatile memory, a memory controller for controlling the device, and a nonvolatile memory system.

### BACKGROUND ART

A nonvolatile memory device having a rewritable nonvolatile main memory is widely demanded mainly as a semiconductor memory card. There are various types of the semiconductor memory cards, and one of them is an SD memory card (a registered trademark). The SD memory card includes a flash memory as the nonvolatile main memory and has a memory controller for controlling the flash memory. The memory controller performs a reading and writing control on the flash memory in accordance with reading and writing commands from an access device such as a digital still camera and personal computer (PC).

The way of a data access, after the SD memory card is mounted to the access device such as the PC, managed by the PC using a FAT file system with recognizing the SD memory card as a removable disk will be explained.

The FAT file system is a system for ordering data reading and writing normally in units of “clusters” by using a file allocation table (FAT) when recording a file and data to a recording device. The cluster is a unit composed by aggregating a plurality of “sectors” each of which is a minimum unit for data writing.

In the flash memory constituting the SD memory card, a page size that is a writing unit for the flash memory and a sector size that is the aforementioned minimum unit for data writing are conventionally the same as 512 bytes for example, however, a flash memory such as a multi-level NAND flash memory in which the page size is 2 kbytes has been becoming mainstream in recent years with needs for increasing a capacity and a speed of the flash memory.

In a memory card composed of the flash memory, suppose that data of 1 sector in a logical sector number (hereinafter referred to as LS) 0 is rewritten for example. When data of 4 sectors from LS0 to LS3 has already written into the memory card, the data of 3 sectors from LS1 to LS3 is read and the read data of the 3 sectors and writing data of 1 sector in LS0 are newly written into a first page of an erased physical block. Hereinafter, the reading and writing processing for the 3 sectors is referred to as an “evacuation processing”. Patent document 1 discloses a technique for the rewriting processing for example.

Here is an outline of a processing procedure of the “rewriting method with the evacuation processing”. The sectors are arranged so as to be logical sector numbers 0, 1, and so on in a logical order, that is, in the order from a lower address side in the physical block (from a side having a smaller address value), and data is written in a following procedure.

1. A step for receiving a logical address assigned from the access device.

2. A step for converting the logical address into a physical address on the main memory.

3. A step for reading old data which is not changed (for example, data of LS1 to LS3) from the flash memory into a buffer memory such as an SRAM when only 1 sector of data stored in a page (for example, data of the sector number 0) is rewritten to new data.

4. A step for writing new data to the buffer memory.

5. A step for writing the data of LS0 to LS3 temporarily stored in the buffer memory into an erased physical block other than the physical block including said page.

6. A step for allocating the physical block storing the old data to an unused physical block.

7. A step for erasing contents of the unused physical block.

As is clear from the above-mentioned explanation, the “rewriting method with the evacuation processing” is complicated and takes long time since requiring the evacuation processing for old data which will not be changed despite rewriting of 1 sector.

A technique dealing with the problem is disclosed in Patent document 2 for example. Patent document 2 discloses the technique replacing the above-mentioned buffer memory with a nonvolatile RAM.

The flash memory employing the method does not restricts the arrangement order of the sectors in the physical block to the logical order, and performs the writing on from the lower page side of the physical block in the order of the writing order. In addition, the method manages a recording state, namely judges whether valid data is stored or invalid old data is stored in each of the pages where data is written in each sector, and is referred to as “a recordable rewriting method”.

In the recordable rewriting method, the writing itself is performed at relatively high speed since the evacuation processing does not occur for each data writing commanded issued by the access device, however, aggregation processing is required at a certain timing. The aggregation processing is for collecting only valid sectors from predetermined blocks and copying the sectors into another erased block and for erasing the blocks which have been invalid.

Patent document 1: U.S. Pat. No. 6,760,805
Patent document 2: Japanese Unexamined Patent Publication No. Hei05-27924

### DISCLOSURE OF THE INVENTION

### Problems to be Solved by the Invention

The aggregation processing in the above-mentioned recordable rewriting method takes relatively long time, thus an average performance in data writing of the recordable rewriting method is not so high when considering time consumed by the processing.

In view of above-mentioned problems, the present invention intends to provide a memory controller, nonvolatile memory device, and nonvolatile memory system which can rationalize the evacuation processing compared to a conventional method and perform data writing at high speed, in a rewriting method with the evacuation processing.

### Means to Solve the Problems

To solve the problems, a memory controller according to the present invention for writing data given from outside into a nonvolatile main memory including a plurality of pages which are writing units having a capacity larger than a sector that is a minimum writing unit from the outside and for reading data from said main memory comprises: an auxiliary memory able to store data of at least 2 sectors or more for temporarily storing data to be written into said main memory; and a reading and writing control part for writing the data into said main memory after collectively reading the data temporarily stored in said auxiliary memory.

When logically consecutive data of a plurality of sectors are temporarily stored in said auxiliary memory, said reading and writing control part may write said data of a plurality of sectors into said main memory.

Said memory controller may further comprises a writing completion notification part for notifying completion of writing to the outside when data of at least 1 sector transferred from the outside has been temporarily stored in said auxiliary memory.

To solve the problems, a nonvolatile memory device according to the present invention comprising a nonvolatile main memory and a memory controller for writing data given from outside into said nonvolatile main memory and reading data from said main memory, wherein said main memory includes a plurality of pages which are writing units having a capacity larger than a sector that is a minimum writing unit from the outside, and said memory controller includes: an auxiliary memory able to store data of at least 2 sectors or more for temporarily storing data to be written into said main memory; and a reading and writing control part for writing the data into said main memory after collectively reading the data temporarily stored in said auxiliary memory.

When logically consecutive data of a plurality of sectors are temporarily stored in said auxiliary memory, said reading and writing control part may write the data of a plurality of sectors into said main memory.

Said memory controller may further include a writing completion notification part for notifying completion of writing to the outside when data of at least 1 sector transferred from the outside has been temporarily stored in said auxiliary memory.

To solve the problems, a nonvolatile memory system according to the present invention comprising a nonvolatile memory device and an access device, wherein said access device accesses said nonvolatile memory device and sends commands, logical addresses, and data, said nonvolatile memory device includes: a main memory including a plurality of pages which are writing units having a capacity larger than a sector that is a minimum writing unit from outside; and a memory controller for writing data into said main memory and reading the data stored in said main memory in accordance with the logical address transferred from said access device, and said memory controller includes: an auxiliary memory able to store data of at least 2 sectors or more for temporarily storing data to be written into said main memory; and a reading and writing control part for writing the data into said main memory after collectively reading the data temporarily stored in said auxiliary memory.

When logically consecutive data of a plurality of sectors are temporarily stored in said auxiliary memory, said reading and writing control part may write the data of a plurality of sectors into said main memory.

Said memory controller may further include a writing completion notification part for notifying completion of writing to outside when data of at least 1 sector transferred from said access device has been temporarily stored in said auxiliary memory.

The auxiliary memory may be a nonvolatile RAM and may be composed of, for example, one of a ferroelectric memory (FeRAM), a magnetic recording random access memory (MRAM), an ovonic unified memory (OUM), and a resistance RAM (RRAM).

### EFFECTIVENESS OF THE INVENTION

According to the present invention, when data given from outside is written into a main memory, the evacuation processing can be rationalized and data writing can be performed at high speed since the data is stored in the main memory after temporarily storing said data into an auxiliary memory (buffering) and then collectively retrieving the pieces of data in the auxiliary memory. Since a plurality of sectors can be collectively written into pages of a nonvolatile memory, the number of executions of the evacuation processing can be reduced even in the case where a multi-level NAND flash memory which does not ensure divided writing of a page is used.

### BRIEF DESCRIPTION OF DRAWINGS

FIG. 1 is a block diagram showing a configuration of a nonvolatile memory system according to an embodiment of the present invention.

FIG. 2 is a view showing a format of a physical block, a plurality of which is included in a flash memory of the nonvolatile memory device according to the same embodiment.

FIG. 3 is a schematic view showing a format of a buffer memory of the nonvolatile memory device according to the same embodiment.

FIG. 4 is a flowchart showing writing processing of a reading and writing control part of the nonvolatile memory device according to the same embodiment.

FIG. 5 is a pattern diagram showing a flow of rewriting processing of the nonvolatile memory system according to the same embodiment.

FIG. 6 is a pattern diagram showing a flow of rewriting processing of the nonvolatile memory system according to a conventional example.

### EXPLANATION FOR REFERENCE NUMERALS

100 Access device
110 Nonvolatile memory device
120 Memory controller
121 CPU part
122 Nonvolatile auxiliary memory (Buffer memory)
123 Reading and writing control part
124 Writing completion notification part
130 Nonvolatile main memory (Flash memory)

### BEST MODE FOR CARRYING OUT THE INVENTION

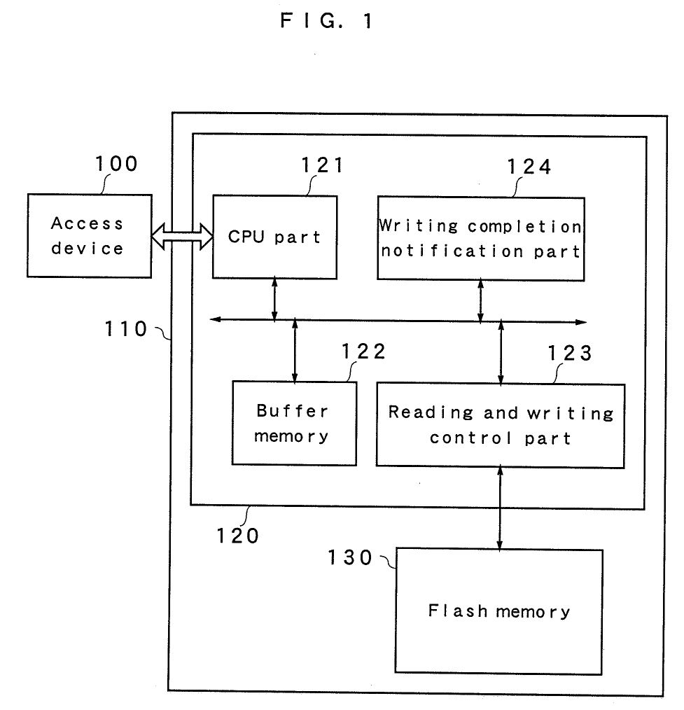

Referring to drawings, a nonvolatile memory system according to an embodiment of the present invention will be explained below. FIG. 1 is a block diagram showing a configuration of the nonvolatile memory system according to the embodiment. The nonvolatile memory system includes an access device 100 and a nonvolatile memory device 110 connected to the access device 100.

The nonvolatile memory device 110 comprises a memory controller 120 and a flash memory 130, and is able to access the access device 100 set outside of the memory device. The flash memory 130 is a nonvolatile main memory and is composed of a plurality of physical blocks described below.

The access device 100 sends reading and writing commands for commanding the flash memory 130 via the memory controller 120 to read and write user data (hereinafter simply referred to as data), sends a logical address in which the data is stored, and sends and receives data. Upon receiving the reading and writing commands from the access device 100, the memory controller 120 writes received data into the flash memory 130, and read data from the flash memory 130 and outputs the data to the access device 100.

Details of the nonvolatile memory device 110 will be described below. The memory controller 120 installed in the nonvolatile memory device 110 includes a CPU part 121, a buffer memory 122, a reading and writing control part 123, and writing completion notification part 124. The CPU part 121 performs a control of the sending and receiving data to the access device 100, an address management in the reading and writing to the flash memory 130, and so on. The buffer memory 122 is a nonvolatile auxiliary memory for temporarily storing data to be written into the flash memory 130 and data read from the flash memory 130.

The buffer memory 122 is preferably composed of a nonvolatile RAM, for example, a ferroelectric memory (FeRAM), a magnetic recording random access memory (MRAM), an ovonic unified memory (OUM), and a resistance RAM (RRAM).

The reading and writing control part 123 writes data into the flash memory 130 and reads data in the flash memory 130 based on physical addresses specified by the CPU part 121. The reading and writing control part 123 also controls reading and writing of data stored in the buffer memory 122.

The writing completion notification part 124 writes data into the buffer memory 122 when a data writing command and data are transferred from the access device 100 and then notifies completion of the writing to the access device 100 side every time a stop command is given.

Since a logical-physical conversion processing executed by the CPU part 121, that is, address management processing such as processing for converting a logical address specified by the access device 100 into an physical address of the flash memory 130 is commonly known technique, an explanation for the processing is omitted to simplify the description.

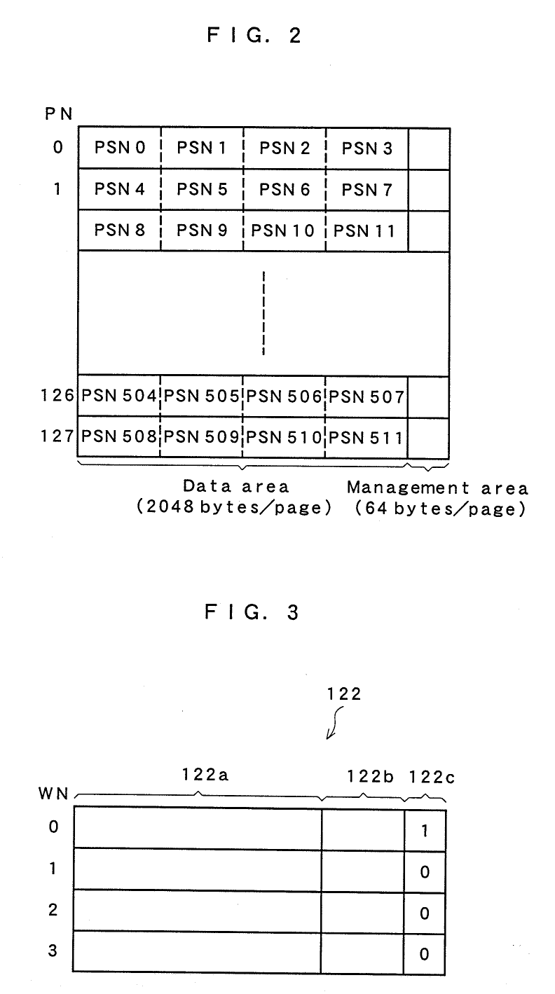

FIG. 2 shows a format of a physical block set in the flash memory 130. As shown in FIG. 2, the physical block is composed of 128 pages from PN0 to PN127. Each page is composed of a data area of 4 sectors and a management area. In the embodiment, 1 sector takes 512 bytes, and 1 page is composed of 4 sectors and takes 2048 bytes. The management area is an area for recording information necessary for the address management processing of the CPU part 121, however, detailed explanation about the area is omitted.

In addition, physical arrangement numerals such as PSN0, PSN1, to PSN511 is added from the top left of FIG. 2. The PSN is an abbreviation made by initial letters of Physical Sector Number.

FIG. 3 shows a format of the buffer memory 122. As shown in this drawing, the buffer memory 122 has a capacity able to temporarily store data of 1 page of a physical block and a logical address, and is divided into 4 words. Word numbers WN are numbered by 0 to 3. Each word is divided into a data area 122a, a logical address area 122b, and a buffer pointer flag area 122c. The data area 122a stores 1 sector, that is, data of 512 bytes, and the logical address area stores a logical address of the data. The logical address is an address of sector units, and has the bit number (21 bits) allowing identification of sectors in 1 GBytes.

The buffer pointer flag area 122c stores a buffer pointer flag of 1 bit for identifying the word number. The buffer memory 122 temporarily stores data transferred from the access device 100, and a buffer pointer bp allows identifying which word stores data next. The buffer pointer flag shows information where a word number is indicated by the buffer pointer bp, and it is assumed that the buffer pointer bp indicates a word number having a value “1”. The reading and writing control part 123 increments the buffer pointer bp in units of the word number by moving a position where the buffer pointer bp is a value “1” in units of the word number.

Referring to drawings, an operation of the nonvolatile memory system according to the embodiment of the present invention will be explained.

### (Initial State)

Contents of the buffer 122 and the flash memory 130 immediately after a shipment will be explained first. To simplify the description, explanation of a system area such as a maker code and security information recorded in the flash memory 130 is omitted, and only a normal area, that is, an area on which a user performs the reading and writing data will be explained.

Good blocks in the flash memory 130 and the buffer memory 122 immediately after the shipment are in all erased state. Further in the buffer memory 122, a value “1” is set in the buffer pointer flag area of the word number WN0.

In an initialization after the power is activated, the CPU part 121 makes prior arrangement so as to manage states of the respective physical blocks in the flash memory 130. Details are omitted.

When the initialization processing is completed, the memory controller 120 enters a state for accepting the reading and writing commands and so on from the access device 100.

### (Processing in a Normal Operation)

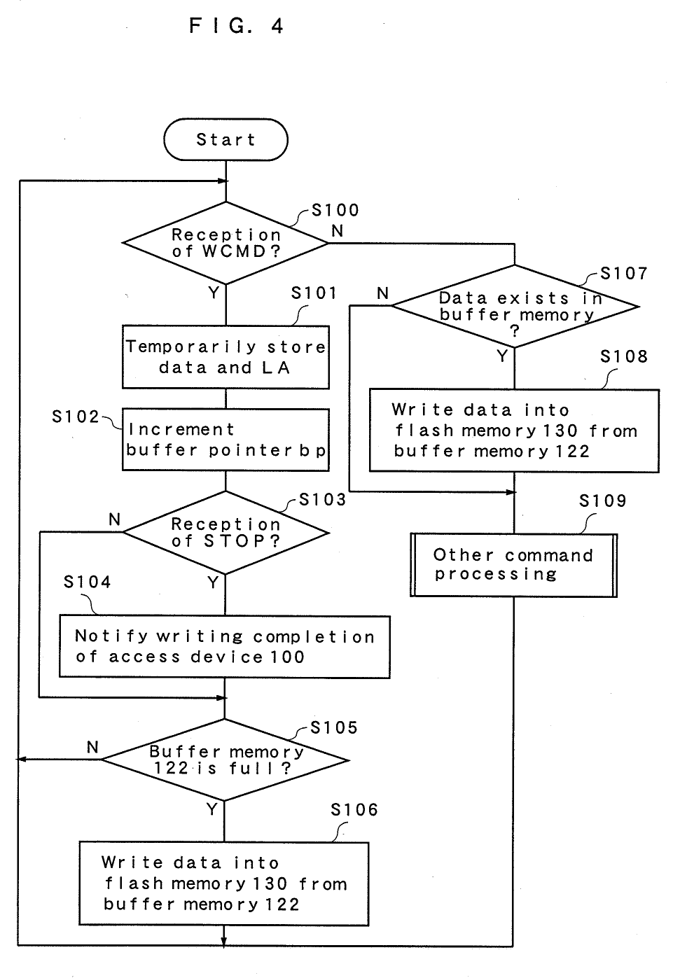

Writing processing in a normal operation after the initialization will be explained. Concretely, the buffer memory 122 temporarily stores data transferred from the access device 100, and then the temporarily stored data is written into the flash memory 130. FIG. 4 shows a flowchart of a series of the writing processing in the reading and writing control part 123.

In FIG. 4, the nonvolatile memory device 100 waits for the receiving of a command from the access device 100 immediately after the completion of the initialization processing. When the commend transferred from the access device 100 is a writing command (hereinafter referred to as a WCMD) and data and a logical address of the data are received subsequent to the WCMD (S100), the reading and writing control part 123 temporarily stores the data of 1 sector and the logical address LA (a logical sector number) in the buffer memory 122 (S101). The control part increments the buffer pointer bp subsequently (S102). The control part checks whether or not a transfer termination command (hereinafter referred to as a stop command) has been transferred from the access device 100 (S103). When the stop command is received, the memory controller 120 notifies a completion of the writing to the access device 100 through the writing completion notification part 124 (S104). At step S105, the control part checks whether all areas in the buffer memory store data (full) or not. When not all of the areas store data, the processing returns to step S100. When all of the 4 sectors of the buffer memory 122 temporarily stores data, the buffer memory 122 cannot further store data and the reading and writing control part 123 collectively writes data of the 4 sectors into a page of a determined physical block in the flash memory 130 from the buffer memory 122 (S106). The determined physical block is a physical block identified by the address management processing such as the logical-physical conversion in the CPU part 121, and an explanation of how to specify the physical block is omitted.

Moreover, at S100, when the command is not the writing command (the WCMD), the processing goes to S107, and the control part checks whether or not the buffer memory 122 stores data. When data is stored, the control part writes data of the buffer memory 122 into the flash memory 130 (S108) and performs the evacuation processing. And, the control part performs processing in accordance with the command (S109). When the buffer memory stores no data, the control part performs other processing without performing this processing. In this manner, the memory controller 120 can temporarily store data read from the flash memory 130 into the buffer memory 122 when the access device issues a reading command.

Since the buffer memory 122 is a nonvolatile memory in this embodiment, the buffer memory 122 temporarily stores data of 1 sector, and the notification part notifies the completion of the writing to the access device 100 upon receiving the stop command. However, the completion of the writing may be notified immediately after the buffer memory 122 stores the data, and the completion of the writing may be notified after the data is written into the flash memory 130 from the buffer memory 122 when the buffer memory 130 has stored data in all the areas regardless of existing of the stop command.

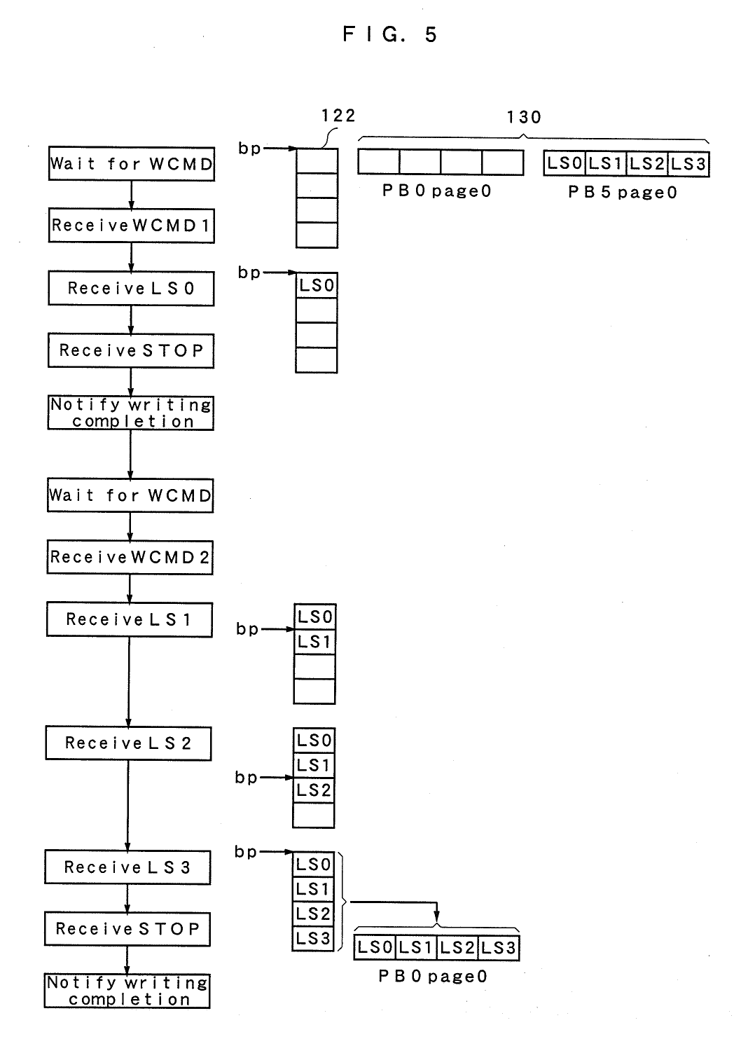

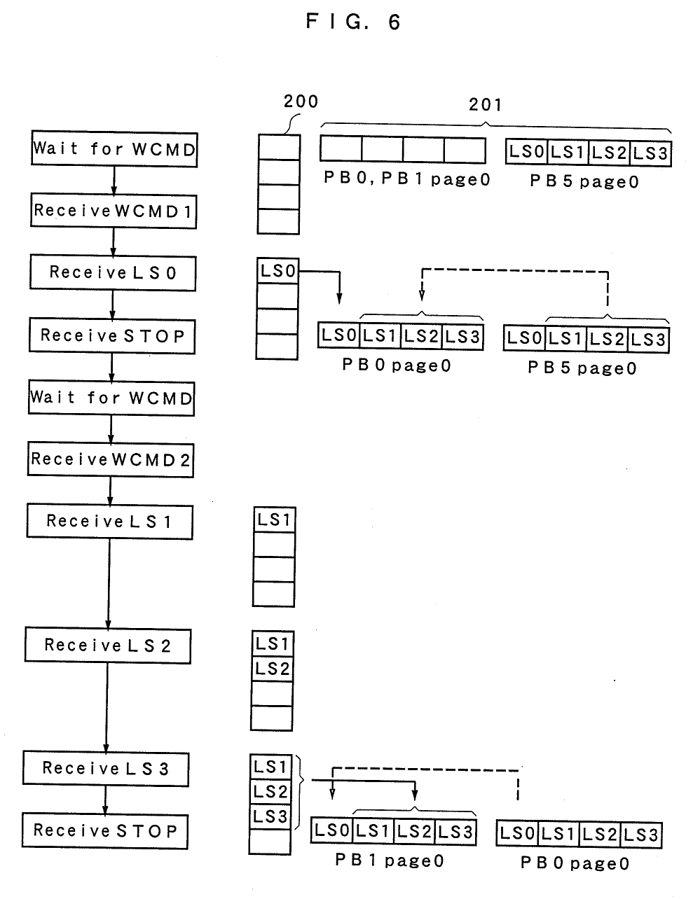

Based on the above-mentioned writing processing of the reading and writing control part 123, an example of a case where the access device 100 rewrites data of the 4 sectors from the logical sector numbers 0 to 3 will be explained. To clarify a difference between the embodiment of the present invention and the conventional technique, the operation of the embodiment will be explained referring to FIG. 5 first and then that of the conventional technique will be explained referring to FIG. 6.

FIG. 5 schematically shows a flow of the rewriting processing of the nonvolatile memory system according to the embodiment. In FIG. 5, it is assumed that the data of LS0 to LS3 has already been stored in a page 0 of the physical block PB5 in the flash memory 130. Moreover, it is assumed that new data transferred from the access device 100 will be written into a page 0 of a physical block PB0 that is an erased block in the flash memory 130. The access device 100 transfers WCMD twice, and the first WCMD is represented by WCMD1 and the next WCMD is represented by WCMD2.

When the nonvolatile memory device 110 receives WCMD1 and then receives data of the logical sector number 0 (LS0), the buffer memory 122 temporarily stores the data as shown in FIG. 5. The access device 100 transfers the stop command (STOP) immediately after transferring data of 1 sector, LS0. In response to this, the memory controller 120 informs the completion of the writing.

After that, the access device 100 transfers WCMD2 and continuously transfers data of 3 sectors from the logical sector number 1 to the logical sector number 3 (LS1, LS2, and LS3). The nonvolatile memory device 110 temporarily stores LS1, LS2, and LS3 into the buffer memory 122 in sequence following LS0. The buffer pointer bp is sequentially incremented on this occasion.

When LS3 is stored, the buffer memory becomes full, and the reading and writing control part 123 recognizes the buffer memory is full and collectively writes LS0 to LS3 temporarily stored in the buffer memory 122 into the page 0 of the erased physical block PB0. The old data of LS0 to LS3 is stored into the page 0 of the physical block PB5, however, the evacuation processing for the old data is unnecessary since the new data of LS0 to LS3 is collectively written into the page 0 of the physical block PB0. After that, upon receiving the stop command, the notification part sends a notification of writing completion to the access device 100. Moreover, the page 0 of the physical block PB5 storing the old data is erased at a certain timing, however, the erase operation is omitted to simplify the description.

The conventional technique will be explained next referring to FIG. 6. A conventional nonvolatile memory device uses a volatile memory, for example, an SRAM as a buffer memory and has written data into a flash memory 201 from a buffer memory 200 in units of processing from the WCMD to the STOP in consideration of the power shutdown. In addition, the buffer memory is assumed to have a capacity of 4 sectors.

It is assumed that the old data of LS0 to LS3 has already been written in the page 0 of the physical block PB. In addition, physical blocks PB0 and PB1 into which new data is to be written are assumed as erased blocks.

In FIG. 6, after WCMD1 is received, the buffer memory 200 temporarily stores LS0. Upon receiving the stop command, LS0 in the buffer memory 200 is written at a position of PSN0 in the page 0 of the physical block PB0 and LS1 to LS3 in the old data stored in the page 0 of the physical block PB0 are simultaneously written at positions of PSN1 to PSN3 in the page 0 of the physical block PB0 as shown by a broken line. The evacuation processing is realized in this manner.

Then, at a time when the access device transfers WCMD2 and continuously sends LS1 to LS3 in sequence, the nonvolatile memory device sequentially writes the data LS1 to LS3 into the buffer memory 200. Upon further receiving the stop command, the nonvolatile memory device writes the data LS1 to LS3 into predetermined new sector memory positions in a page 0 of the physical block PB1 as shown by a solid line. At the same time, the nonvolatile device writes LS0 of the old data stored in the page 0 of the physical block PB0 into the page 0 of the physical block PB1 as shown by a broken line.

The example of the rewriting processing has been described above with using FIG. 5 and FIG. 6 by comparing the operation according to the embodiment of the present invention with the operation according to the conventional example, and the example has proven that the present embodiment reduces the number of executions of the evacuation processing and that the rewriting speed of the embodiment is fast as compared to those of the conventional example. Specifically, the conventional example of the rewriting for LS0 to LS3 requires page-writing twice, however, the present embodiment completes the rewriting by the single page-writing.

In the rewriting processing according to the embodiment of the present invention shown in FIG. 5, the nonvolatile buffer memory 122 temporarily stores data transferred from the access device once and the data is collectively written in pages when the stop command has been transferred or the buffer memory 122 has been fully filled with the data. Accordingly, even for a memory such as a multi-level NAND flash memory which does not ensure divided writing, the embodiment according to the present invention has effectiveness of reducing the number of executions of the evacuation processing. Moreover in the embodiment of the present invention, the writing to the flash memory 130 is performed when the buffer memory 122 is fully filed with data, however, the writing to the flash memory 130 may be performed when data of predetermined sectors more than 2 sectors are temporarily stored. This case requires the evacuation processing, but the number of execution of the evacuation processing can be smaller than that in the conventional rewriting. In addition, since the buffer memory 122 includes a logical address area, the reading and writing control part 123 reads data from the buffer memory 122 based on the logical sector numbers stored in the logical address area and simply transfers the data to the flash memory 130 even when the access device 100 sends writing commands which are not in the logical address order, for example, in the order of LS2, LS0, LS3, and LS1.

### INDUSTRIAL APPLICABILITY

The memory controller, nonvolatile memory device, and nonvolatile memory system according to the present invention can perform the fast data writing by using, as a main memory, a nonvolatile memory such as the flash memory including a writing unit (the page) having a capacity larger than a minimum writing unit (the sector) from the access device and by rationalizing the evacuation processing with using a nonvolatile memory as the buffer memory. The device according to the present invention can be used as a portable AV apparatus such as a still image recording and reproducing device and a moving image recording and reproducing device or as a recording medium for a portable communication apparatus such as a mobile phone.

1. A memory controller for writing data given from outside into a nonvolatile main memory including a plurality of pages which are writing units having a capacity larger than a sector, a minimum writing unit from the outside, and which do not ensure divided writing at least in units of said sectors and for reading data from said main memory comprising:
an auxiliary memory able to store data of at least 2 sectors or more for temporarily storing data to be written into said main memory; and
a reading and writing control part for writing the data into said main memory after collectively reading the data temporarily stored in said auxiliary memory.

2. The memory controller according to claim 1, wherein,
when logically consecutive data of a plurality of sectors are temporarily stored in said auxiliary memory, said reading and writing control part writes said data of a plurality of sectors into said main memory.

3. The memory controller according to claim 1, wherein
said memory controller further comprises a writing completion notification part for notifying completion of writing to the outside when data of at least 1 sector transferred from the outside has been temporarily stored in said auxiliary memory.

4. A nonvolatile memory device comprising a nonvolatile main memory and a memory controller for writing data given from outside into said nonvolatile main memory and for reading data from said main memory, wherein
said main memory includes a plurality of pages which are writing units having a capacity larger than a sector, a minimum writing unit from the outside, and which do not ensure divided writing at least in units of said sectors, and
said memory controller includes:
an auxiliary memory able to store data of at least 2 sectors or more for temporarily storing data to be written into said main memory; and
a reading and writing control part for writing the data into said main memory after collectively reading the data temporarily stored in said auxiliary memory.

5. The nonvolatile memory device according to claim 4, wherein
when logically consecutive data of a plurality of sectors are temporarily stored in said auxiliary memory, said reading and writing control part writes said data of a plurality of sectors into said main memory.

6. The nonvolatile memory device according to claim 4, wherein
said memory controller further includes a writing completion notification part for notifying completion of writing to the outside when data of at least 1 sector transferred from the outside has been temporarily stored in said auxiliary memory.

7. A nonvolatile memory system comprising a nonvolatile memory device and an access device, wherein
said access device accesses said nonvolatile memory device and sends commands, logical addresses, and data,
said nonvolatile memory device includes:
a main memory including a plurality of pages which are writing units having a capacity larger than a sector, a minimum writing unit from outside, and which do not ensure divided writing at least in units of said sectors; and
a memory controller for writing data into said main memory and for reading the data stored in said main memory in accordance with the logical address transferred from said access device, and
said memory controller includes:
an auxiliary memory able to store data of at least 2 sectors or more for temporarily storing data to be written into said main memory; and
a reading and writing control part for writing the data into said main memory after collectively reading the data temporarily stored in said auxiliary memory.

8. The nonvolatile memory system according to claim 7, wherein
when logically consecutive data of a plurality of sectors are temporarily stored in said auxiliary memory, said reading and writing control part writes said data of a plurality of sectors into said main memory.

9. The nonvolatile memory system according to claim 7, wherein
said memory controller further includes a writing completion notification part for notifying completion of writing to outside when data of at least 1 sector transferred from said access device has been temporarily stored in said auxiliary memory.
